(19) United States
(12) Patent Application Publication
(10) Pub. No.: US 2011/0305610 A1
(43) Pub. Date: Dec. 15, 2011

(54) METHOD FOR IMPREGNATING A POROUS BODY BY A SUSPENSION AND INSTALLATION FOR IMPLEMENTING SAME

(76) Inventors: Arnold Lambert, Chavanay (FR); Philippe Leminter, Lyon (FR); Thierry Becue, Lyon (FR); Jean-Pierre Joulin, Grabels (FR); Bruno Cartoixa, Salindres (FR)

(21) Appl. No.: 12/377,928

(22) PCT Filed: Aug. 14, 2007
(86) PCT No.: PCT/FR2007/001370

§ 371 Date: Aug. 2, 2011

(30) Foreign Application Priority Data
Aug. 18, 2006 (FR) 06/07399

(51) Int. Cl. B01D 39/00; B05D 7/00; B01D 53/86; B05C 11/00; B01D 46/00; B01D 37/00; B05D 5/00; B05C 9/02

(52) U.S. Cl. 423/210; 427/256; 118/50; 95/285; 210/767

(57) ABSTRACT

The present invention relates to a method for impregnating a porous body (14) by a suspension (12) containing at least partly particles, said body comprising a multiplicity of channels (16) delimited by porous walls (22) extending from one (18) of the faces to the other (20) face of said body, part of said channels being obstructed at one face and the other part of the channels being obstructed at the other face.

According to the invention, the method consists in:
making a suspension whose particle size distribution meets a D_{V90}/Dₚₒᵣₑₛ ratio below 0.25 and whose viscosity is such that said suspension is brought inside the walls while depositing part of the particles on the surface of the pores of the walls,
communicating one (18, 20) of the faces of body (14) with an enclosure (30) containing the suspension,
feeding the suspension into the body,
exerting a force on the suspension introduced so that said suspension flows through the walls,
passing a fluid through the walls.

### FIELD OF THE INVENTION

The present invention relates to a method for impregnating a porous body with a suspension, in particular a monolithic honeycomb body, and to an installation for using same.

It more particularly relates to a monolith made of a porous ceramic material used for filtration of a gas stream or a liquid stream.

The invention especially but not exclusively aims at a method for coating a porous body used as a Particle Filter (PF) for the exhaust gas of an internal-combustion engine, notably of diesel type.

### BACKGROUND OF THE INVENTION

The exhaust gas of diesel type internal-combustion engines generally comprises particles or soots that are discharged into the atmosphere and such discharge is harmful to man's health. This gas also contains other pollutants such as carbon oxides CO, nitrogen oxides NOx (nitrogen monoxide NO and nitrogen dioxide NO₂) and unburnt hydrocarbons, which are discharged into the atmosphere without being treated and are therefore also injurious to health.

In order to overcome this nuisance, systems intended to treat these pollutants are installed in some engines and are better known as catalyzed particle filters that can treat all or part of the pollutants contained in the exhaust gas. Thus, particle treatment is performed by trapping, then by oxidizing the trapped particles, HC and CO treatment can be achieved by catalytic oxidation reaction and NOx treatment by adsorption, then by desorption/catalytic reduction or by selective catalytic reduction.

To carry out such treatments, it is well known to use a catalyzed filter consisting of a monolithic body made up of a refractory porous material and comprising a multiplicity of channels arranged between the two end faces of this body. The channels are arranged in the direction of the gas stream to be treated and they are separated from one another by porous walls. The channels are alternately blocked, at the level of the faces of the body, at one end or at the other end thereof, so as to foam inlet channels with open ends opposite the gas stream and outlet channels with blocked ends opposite this gas stream. Thus, the exhaust gas stream flows into the inlet channels, then through the porous walls separating the inlet channels from the outlet channels, and it eventually flows out through these outlet channels. As the stream flows therethrough, the particles contained in the gas stream are retained on the walls and the gas that circulates in the outlet channels is freed of a large part of these particles. The particles thus collected are then burnt in situ, notably as the temperature of the exhaust gas circulating in the filter rises, so as to provide filter regeneration.

Particle elimination can also be facilitated by addition of at least one catalytic formulation or catalyst, notably a particle oxidation catalyst.

In known embodiments, this catalyst is incorporated in the particle filter, thus achieving a catalyzed particle filter allowing the particle oxidation temperature to be lowered.

Thus, in patent application EP-0,160,482 or in patent application JP-2002/066,338, the washcoat layer, which is a solid film resulting from operations of drying and calcining the body impregnated by a suspension containing a catalytic formulation, is deposited on the surface of the walls of the channels making up the particle filter.

This has the disadvantage of significantly increasing pressure drops when the amount of deposited washcoat is large.

Patent applications EP-1,338,322, EP-1,403,231 and US-2005/0,056,004 describe a method of incorporating a sol-gel type solution into the pores of the particle filter by impregnation of solutions containing soluble precursors of the oxides considered, which are subsequently precipitated or hydrolyzed/condensed, then dried and calcined.

The amount of washcoat deposited within the pores by means of these methods is however low, or even insufficient, or it requires many successive deposition operations.

Document WO-00/01,463 describes the introduction of a suspension within the pores of a particle filter of very high porosity. Considering this high porosity, the particle filtration performances are minimal. Thus, in order to obtain sufficient filtration efficiency, a filtration membrane of smaller pore size distribution is added on the gas outlet side of the particle filter so as to stop the particles. This has the drawback of complicating the impregnation process and of requiring a membrane.

In order to overcome the aforementioned drawbacks, the present invention provides a simple and inexpensive impregnation method wherein the quality of the catalytic phase deposition within the walls can be controlled.

### SUMMARY OF THE INVENTION

The present invention therefore relates to a method for impregnating a porous body by a suspension containing at least partly particles, said body comprising a multiplicity of channels delimited by porous walls extending from one of the faces to the other face of said body, part of said channels being obstructed at one face and the other part of the channels being obstructed at the other face, characterized in that the method consists in:

making a suspension whose particle size (or grain size) distribution meets a D_{V90}/Dₚₒᵣₑₛ ratio below 0.25 and whose viscosity is such that said suspension is brought inside the walls while depositing part of the particles on the surface of the pores of the walls,

communicating one (18, 20) of the faces of body (14) with an enclosure (30) containing the suspension,

feeding the suspension into the body,

exerting a force on the suspension introduced so that said suspension flows through the walls,

passing a fluid through the walls.

The method can consist in exerting a pressure on the suspension introduced.

The method can also consist in exerting an underpressure on the suspension introduced.

Advantageously, the method can consist in using a gas as the fluid.

Preferably, this method can consist in using an inert gas as the fluid.

It can consist in carrying out at least another suspension impregnation in the body.

It can also consist in turning the body over so as to carry out at least another impregnation.

The method can consist in communicating the other face of the body with a collector base.

It can consist in connecting the collector base to a suspension and/or fluid recovery device.

Preferably, the method can consist in placing the body in a sealed sheath.

This method can consist in drying and calcining the body after impregnation.

A porous body impregnated according to the method of the invention can be used for treating at least one pollutant contained in an exhaust gas.

A porous body impregnated according to the method of the invention can also be used for liquid stream filtration.

The invention also relates to an installation for impregnating a porous body, comprising an enclosure containing an impregnation suspension with at least partly particles, said enclosure communicating with one of the faces of the body, characterized in that it comprises a device for pressurizing the enclosure.

The installation can comprise a sealed sheath intended to receive the porous body.

The installation can comprise a sealing membrane between the sheath and the body.

This membrane can be an expansible, notably an inflatable membrane.

The installation can comprise a collector base that can include suspension discharge means.

The D_{V90}/Dₚₒᵣₑₛ ratio defined in the present invention is strictly positive. It can be preferably above 0.001, more preferably above 0.01.

### BRIEF DESCRIPTION OF THE FIGURES

Other features and advantages of the invention will be clear from reading the description hereafter, given by way of non limitative example, with reference to the accompanying figures wherein:

FIG. 1 is a diagram showing, in axial section, an impregnation installation using the method according to the invention,

FIG. 2 is a cross-sectional diagram along line AA of FIG. 1, and

FIG. 3 is a graph showing the pressure drop evolution as a function of the amount of washcoat obtained with the method according to the invention and with the method according to the prior art.

### DETAILED DESCRIPTION

FIG. 1 shows an installation 10 for impregnating a porous body 14 by a suspension 12.

In the example shown, body 14 preferably is a monolithic honeycomb ceramic body. The ceramic material can be silicon carbide, silicon nitride, cordierite, mullite, sialon, boron nitride, silica, alumina, aluminosilicates, aluminium titanate or zirconium phosphate, and it can concern a pure (single ceramic composition) or composite (several different ceramic compositions) ceramic material.

This body comprises a multiplicity of substantially parallel channels 16 extending from an end face 18 of this body to another end face 20. These channels are separated from one another by porous walls 22 and their section can have any desired shape (circular, square, rectangular, triangular, etc.). These channels comprise plugs 24 at one or at the other end thereof so as to form inlet 26 and outlet 28 channels. The inlet channels comprise open ends at the level of face 18 and blocked ends at the level of face 20, whereas outlet channels 28 comprise blocked ends opposite face 18 and open ends opposite face 20.

After impregnation, the body can be used either as a catalyzed particle filter for treating the pollutants (particles, CO, NOx and HC) contained in the exhaust gas of an internal-combustion engine or as a membrane for filtration/separation or separation and/or filtration of a liquid or a gaseous stream, such as hydrogen separation.

This body can notably have a number of channels ranging from 50 to 1100 channels per square inch. Advantageously, this number of channels per square inch can range between 50 and 600. Finally and preferably, the number of channels can range between 150 and 350 channels per square inch. The porosity of the walls ranges between 30 and 80% by volume and preferably between 40 and 60%, while the pore size distribution ranges between 10 and 200 μm, preferably between 20 and 50 μm.

The impregnation installation comprises a vertical enclosure 30 with a housing 32 including an upper horizontal opening 34 and a lower horizontal opening 36, with reference to FIG. 1. Upper opening 34 is closed by a cover 38 that is tightly fastened to this housing by any means, through screwing for example, with interposition of a seal 40 between this cover and the rim of the opening of the housing. The cover is provided with an orifice 42 tightly sealed by a plug 44, allowing access to the inside of the enclosure so as to pour suspension 12 containing at least one catalytic phase.

The cover also comprises an inlet line 46 allowing a pressurized fluid 48 to flow into the enclosure and connected to a fluid pressurization installation 50. This installation comprises, as it is known per se, a pressurization pump and a fluid tank (not shown). Preferably, this fluid is a gas, in particular air, and advantageously an inert gas such as nitrogen, notably in cases where the suspension can evolve in an oxidizing or reducing atmosphere. Additionally, the cover is fitted with an overpressure valve 52 allowing part of the pressurized liquid contained in the enclosure to be discharged if the pressure in this enclosure exceeds a limit pressure.

In the vicinity of lower opening 36 and at a distance from the rim thereof, a stop collar 54 extends radially towards the inside of the housing. An upper end of a vertical reception sheath 56 containing body 14 tightly rests on the lower horizontal face of this collar. The sheath is arranged vertically in opening 36 and it is immobilized against the collar by any means, such as screwing of this sheath in the opening, with interposition of a seal 58 between the collar and the upper rim of the sheath. The sheath is a tubular sheath whose internal dimensions substantially correspond to the external dimensions of body 14 so as to tightly receive this body. Thus, in cases where body 14 is a cylindrical body, the inside diameter of the sheath corresponds to the outside diameter of the body and the length of this sheath corresponds to at least the length of this body 14. Advantageously, an expansible, for example inflatable, membrane (not shown) can be arranged between the sheath and the body. Thus, after setting the body in the sheath and inflating the membrane, assembling these two elements is achieved with peripheral sealing all along the sheath.

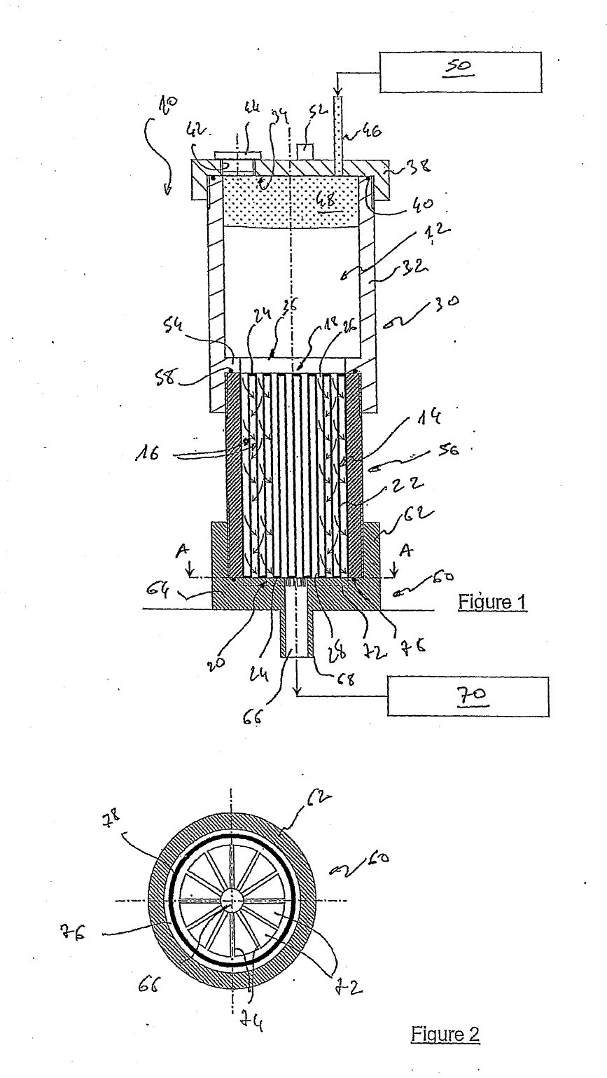

The other end of the sheath is fastened, through screwing for example, to a collector base 60 by tightly resting thereon. This base, advantageously bowl shaped, has a peripheral rim 62 extending towards enclosure 30 and a bottom 64. More precisely, in connection with FIG. 2, bottom 64 is provided with a vertical discharge passage 66 arranged in the central area of the bottom and connected by a line 68 to a recovery device 70 intended to collect the suspension and/or the pressurized gas. Bottom 64 comprises radial collecting slots 72 having the shape of cylinder or pie portions that communicate with passage 66 via their ends that are the closest to this passage.

Advantageously, these slots are arranged at an equal angular distance from one another, here an angle of 30°, and they have the same section while leaving between them radial bearing bars 74 for body 14. Preferably, the diameter of the circle circumscribed to these slots is at least equal to the outside diameter of body 14. A bearing surface 76, annular here, for the other end of the sheath is provided in the continuity of the plane passing through the vertices of bars 74, between the inner face of peripheral rim 62 of the base and the limit of the circle circumscribed to these slots. This bearing surface has dimensions corresponding to the cross-section of the sheath with an inside diameter corresponding to that of the sheath and an outside diameter at least equal to the outside diameter of the sheath. A seal 78 providing sealing between these two elements is thus arranged between bearing surface 76 and the rim of the lower end of the sheath.

Of course, it is also possible to replace seals 58 and 78 by extensions of the expansible sealing membrane described above by forming a single element that will provide sealing, upon inflating, between sheath 56, body 14, housing 30 and base 60.

To achieve impregnation of body 14, base 60 provided with its seal 78 is arranged on a working surface and it is connected to recovery device 70. The lower end of sheath 56 is subsequently placed on this base, then screwed onto rim 62 until this end tightly rests on bearing surface 74 by compressing seal 78. Body 14 is slipped inside sheath 56 in such a way that face 20 of this body rests on bars 74. In this position, face 18 of body 14 is preferably at the same level as the upper end of sheath 56. Enclosure 30 is subsequently placed on the upper end of this sheath, then screwed until this upper end tightly rests on radial collar 54 provided with its seal 58. Suspension 12 containing at least one catalytic phase is fed into the enclosure through opening 42 and fills the inlet channels. Filling is continued up to a level leaving a free space between the cover and this suspension.

The making of the suspension is such that the size distribution of the particles in the suspension, measured by laser diffraction, has to be adjusted to the pore size distribution of the body so as to allow impregnation of the wall without clogging the pores thereof. It thus appeared that the D_{V90}/Dₚₒᵣₑₛ ratio has to be below 0.25 to allow impregnation of the body. Term D_{V90} relates to the dimension for which 90% of the particles in the suspension have a diameter (volume measurement by laser diffraction) that is smaller than this dimension, whereas Dₚₒᵣₑₛ relates to the average size of the pores of the body, measured by mercury porosimetry.

The D_{V90}/Dₚₒᵣₑₛ ratio defined in the present invention is strictly positive when term D_{V90} is evaluated by volume measurements using laser diffraction. Preferably, the D_{V90}/Dₚₒᵣₑₛ ratio is above 0.001 and more preferably above 0.01.

Thus, according to variants of the present invention, we have 0<D_{V90}/Dpores<0.25, preferably 0.001<D_{V90}/Dpores<0.25 and more preferably 0.01<D_{V90}/Dpores<0.25.

Of course, the person skilled in the art will determine the necessary and sufficient volume of suspension to be fed into the enclosure for all the inlet channels 26 to be filled with this suspension. In order to satisfy the D_{V90}/Dpores<0.25 criterion from any type of solid, crushing of the solid using techniques known to the person skilled in the art can be used.

Once the suspension introduced, orifice 42 is closed by plug 44, and line 46 connected to pressurization installation 50 feeds pressurized gas 48 into the free space of enclosure 30. Thus, under the effect of this pressure force, the suspension is driven into channels 26 until it flows through porous walls 22 and ends in outlet channels 28, as illustrated by the arrows in FIG. 1. It can be noted that, considering the presence of sheath 56 and the sealing between the sheath and the body, the suspension cannot flow through the walls arranged on the periphery of body 14. In the rest of the operating process, the suspension that has not been retained by the walls is driven into outlet channels 28 by the pressurized gas and it ends in slots 72. From these slots, the suspension is driven by the gas into discharge passage 66 prior to being sent thereafter through line 68 to the recovery device that can comprise a receiving container for this suspension. Once all of the suspension initially present in the enclosure has flowed through the walls, the pressure is maintained in the enclosure so that the gas flows through these walls with a linear gas velocity in the channels (gas flow rate in relation to the total inflow surface area of the body) ranging between 2500 and 3000 m/h. This allows to discharge the excess suspension contained in the pores of the walls core and to carry out a first drying of the film of the suspension deposited not only on the core of these walls but also on their peripheral surfaces. As for the excess suspension, this pressurized gas circulates in channels 28, slots 72 and passage 66 in order to be either recovered by recovery device 70 or discharged into the atmosphere.

Of course, when making the suspension, the viscosity and the size distribution of the particles of this suspension are controlled by techniques known to the person skilled in the art so as to obtain a suspension satisfying the D_{V90}/Dpores<0.25 criterion and sufficiently fluid to be forced to flow through the walls of the particle filter. Thus, by way of non limitative example, the viscosity can be less than or equal to 20 mPa·s (measured at 1200 s⁻¹). Preferably, this viscosity is less than or equal to 15 mPa·s, and more preferably less than or equal to 10 mPa·s.

Once these operations complete, pressurization installation 50 is stopped and the enclosure is brought to atmospheric pressure. The enclosure is then taken off sheath 56 so as to remove body 14 from this sheath. The body is then stove dried and calcined.

In order to obtain a significant suspension impregnation in the body, it is possible to carry out a succession of impregnations similar to those described above. More particularly, the direction of passage of the suspension in body 14 can be reversed, notably through rotation of this body 14. Thus, after removal of enclosure 30 and access to body 14, the latter is turned over so that the outlet channels become inlet channels and vice versa. The body is then fed into the sheath and operations are started again as described above.

The method described above thus allows to insert solid particles within a porous body without clogging the pores thereof, by judiciously selecting the textural properties of the porous body and by adjusting the characteristics of the suspension used for inserting the particles within the pores of this porous body.

By way of example, the applicant has carried out the comparative tests hereafter by comparing an impregnation according to the invention and an impregnation according to the prior art.

### Method According to the Invention

A catalyst support of formulation 12% BaO, 18% CeO₂, 13% ZrO₂, 57% Al₂O₃ (% by mass) was prepared by coprecipitation of the corresponding nitrates. An aqueous suspension with a dry matter content of 30% was prepared with this catalyst. The grain size was adjusted by means of techniques known to the person skilled in the art so as to obtain a D_{V90}/Dpores ratio of 0.19.

A porous body that can be used as a particle filter, having 40% porosity, was then impregnated in an operation according to the method of the invention by a sufficient proportion of this suspension.

After impregnation, predrying was carried out at ambient temperature by the gas with a drying GHSV of the order of 38000 h⁻¹, then the particle filter was oven dried at a temperature of approximately 150° C.

After calcination of the impregnated particle filter at a temperature close to 600° C., a total amount of about 190 g/l washcoat was obtained, with a pressure drop generated by this washcoat of 15 mbar at 50000 h⁻¹.

Precious metals were then impregnated on the particle filter in a proportion of 1% Pt, 0.2% Pd and 0.2% Rh (% in relation to the mass of washcoat deposited).

Of course, it is possible to deposit the precious metals on the catalyst support prior to suspending it for impregnation.

### Method According to the Prior Art

A sol was prepared by mixing CeCl₂, ZrOCl₂, Ba(NO₃)₂ salts and boehmite at the concentrations required to obtain the same catalytic formulation as in the example of the method according to the invention.

The particle filter was immersed in this solution placed in a closed enclosure, then the assembly was placed under vacuum in order to provide good wetting of all the pores of the particle filter. This filter was subsequently drained, dried and calcined at 600° C. for 2 hours. The operation was repeated several times so as to deposit a sufficient amount of washcoat (fifteen times in order to obtain approximately 180 g/l).

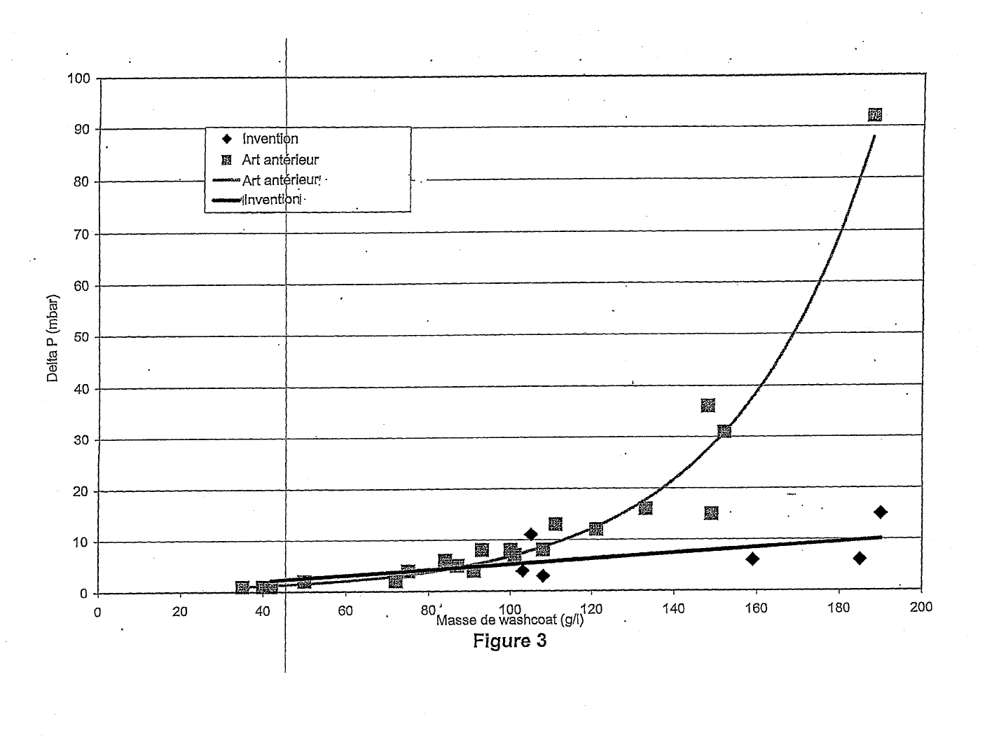

FIG. 3 shows the evolution of the pressure drops as a function of the amount of washcoat deposited by the method according to the invention (“invention” points and trend curve) and by the method according to the prior art (“prior art” D_{V90} points and trend curve), as described above.

Thus, the pressure drops with a high washcoat incorporation rate (of the order of 190 g/l) according to the method of the invention are much lower, of the order of 15 mbar (millibars), than those of the method according to the prior art that are above 90 mbar.

It can also be noted that the incorporation of a large amount of washcoat (about 190 g/l) was achieved in a single operation according to the method of the invention, whereas the method of the prior art requires more than fifteen successive operations to obtain the same amount of washcoat.

The present invention is not limited to the embodiment described above, and it encompasses any variant and equivalent.

Notably, the filtering porous body to be impregnated can be treated thermally or chemically in order to develop a thin oxide layer at the surface of the pores. This oxide layer allows to obtain strong washcoat adherence onto the body to be impregnated.

Furthermore, using a suspension instead of a sol-gel for impregnation of the body has the advantage of allowing incorporation of any type of catalytic formulation (oxidation, SCR, DeNOx, etc.) within the pores of this body. It is in fact possible, by means of techniques known to the person skilled in the art, to prepare a catalytic formulation dedicated to the application considered, then to prepare a suspension based on said formulation, which has the rheological characteristics required for impregnation.

Besides, as mentioned above, several successive impregnations can be carried out, which allows to consider preparing multifunction catalyzed particle filters. This can be done simply by varying the nature of the catalytic formulation incorporated into the suspension during the impregnation operation. Furthermore, the possibility of impregnating the particle filter in opposite directions also allows to consider segregation of the catalysts deposited, with an inlet face and an outlet face having different catalytic functions.

It is also possible to cause the suspension to flow through the wall not by exerting a pressure force on this suspension but by creating an underpressure at the level of the collector base, for example by means of a vacuum pump, so as to suck this solution through the wall and by placing the inside of the enclosure under atmospheric pressure.

1. A method for impregnating a porous body by a suspension containing at least partly particles, said body comprising a multiplicity of channels delimited by porous walls extending from one of the faces to the other face of said body, part of said channels being obstructed at one face and the other part of the channels being obstructed at the other face, characterized in that the method consists in:
making a suspension whose particle size distribution meets D_{V90}/Dₚₒᵣₑₛ ratio below 0.25 and whose viscosity is such that said suspension is brought inside the walls while depositing part of the particles on the surface of the pores of the walls,
communicating one of the faces of the body with an enclosure containing the suspension,
feeding the suspension into the body,
exerting a force on the suspension introduced so that the suspension flows through the walls
passing a fluid through the walls.

2. A method for impregnating a porous body as claimed in claim 1, characterized in that it consists in exerting a pressure on the suspension introduced.

3. A method for impregnating a porous body as claimed in claim 1, characterized in that it consists in exerting an underpressure on the suspension introduced.

4. A method for impregnating a porous body as claimed in claim 1, characterized in that it consists in using a gas as the fluid.

5. A method for impregnating a porous body as claimed in claim 1, characterized in that it consists in using an inert gas as the fluid.

6. A method for impregnating a porous body as claimed in claim 1, characterized in that it consists in carrying out at least another suspension impregnation in the body.

7. A method for impregnating a porous body as claimed in claim 1, characterized in that it consists in turning body over so as to carry out at least another impregnation.

8. A method for impregnating a porous body as claimed in claim 1, characterized in that it consists in communicating the other face of the body with a collector base.

9. A method for impregnating a porous body as claimed in claim 8, characterized in that it consists in connecting collector base to a suspension and/or fluid recovery device.

10. A method for impregnating a porous body as claimed in claim 1, characterized in that it consists in placing body in a sealed sheath.

11. A method for impregnating a porous body as claimed in claim 1, characterized in that it consists in drying and calcining the body after impregnation.

12. Use of a porous body impregnated according to the method as claimed claim 1 for treating at least one pollutant contained in an exhaust gas.

13. Use of a porous body impregnated according to the method as claimed in claim 1 for liquid stream filtration.

14. Installation intended for impregnation of a porous body, comprising an enclosure containing an impregnation suspension with at least partly particles, said enclosure communicating with one of the faces of the body, characterized in that it comprises a device for pressurizing the enclosure.

15. A porous body impregnation installation as claimed in claim 14, characterized in that it comprises a sealed sheath intended to receive body.

16. A porous body impregnation installation as claimed in claim 15, characterized in that it comprises a sealing membrane between the sheath and the body.

17. A porous body impregnation installation as claimed in claim 16, characterized in that the membrane is an expansible membrane.

18. A porous body impregnation installation as claimed in claim 17, characterized in that the membrane is an inflatable membrane.

19. A porous body impregnation installation as claimed in claim 14, characterized in that it comprises a collector base.

20. A porous body impregnation installation as claimed in claim 19, characterized in that collector base comprises suspension discharge means.
